(19) United States
(12) Patent Application Publication
(10) Pub. No.: US 2022/0391587 A1
(43) Pub. Date: Dec. 8, 2022

(54) METHOD OF TRAINING IMAGE-TEXT RETRIEVAL MODEL, METHOD OF MULTIMODAL IMAGE RETRIEVAL, ELECTRONIC DEVICE AND MEDIUM

(71) Applicant: BEIJING BAIDU NETCOM SCIENCE TECHNOLOGY CO., LTD., Beijing (CN)

(72) Inventors: Yuan Feng, Beijing (CN); Xiang Long, Beijing (CN); Honghui Zheng, Beijing (CN); Ying Xin, Beijing (CN); Bin Zhang, Beijing (CN); Chao Li, Beijing (CN); Xiaodi Wang, Beijing (CN); Yi Gu, Beijing (CN); Yunhao Wang, Beijing (CN); Yan Peng, Beijing (CN); Zhuang Jia, Beijing (CN); Shumin Han, Beijing (CN)

(73) Assignee: BEIJING BAIDU NETCOM SCIENCE TECHNOLOGY CO., LTD., Beijing (CN)

(21) Appl. No.: 17/889,074

(22) Filed: Aug. 16, 2022

(30) Foreign Application Priority Data
Aug. 20, 2021 (CN) 202110965035.9

(51) Int. Cl. G06F 40/279; G06V 10/40; G06F 40/58; G06F 16/532; G06F 16/583

(52) U.S. Cl. CPC G06F 40/279; G06V 10/40; G06F 40/58; G06F 16/532; G06F 16/5846

(57) ABSTRACT

A method of training an image-text retrieval model, a method of multimodal image retrieval, an electronic device and a storage medium, each relating to the technical field of artificial intelligence, and in particular, to fields of computer vision and deep learning technologies. Sample data including a sample text and a sample image is acquired. The sample text includes a sample text in a first language and a sample text in a second language. The sample text in the first language and the sample text in the second language are processed by using the text encoding sub-model to obtain a sample text feature of the sample data. The sample image is processed by using the image encoding sub-model to obtain a sample image feature of the sample data. The image-text retrieval model is trained according to the sample text feature and the sample image feature.

This application is claims priority to Chinese Patent Application No. 202110965035.9 filed on Aug. 20, 2021, which is incorporated herein in its entirety by reference.

### TECHNICAL FIELD

The present disclosure relates to a field of artificial intelligence technology, and in particular, to fields of computer vision and deep learning technologies. Specifically, the present disclosure relates to a method of training an image-text retrieval model, a method of multimodal image retrieval, an electronic device and a storage medium.

### BACKGROUND

An acquired image-text pair (a text and an image corresponding to the text) may be mapped to one and the same feature space by using an image text model. A feature distance between an image feature and a text feature is adjusted by way of deep learning and the like, so as to learn a relationship between a monolingual text and the image.

### SUMMARY

The present disclosure provides a method of training an image-text retrieval model, a method of multimodal image retrieval, an electronic device and a storage medium.

According to an aspect of the present disclosure, there is provided a method of training an image-text retrieval model, wherein the image-text retrieval model includes a text encoding sub-model and an image encoding sub-model, and the method includes: acquiring sample data, wherein the sample data includes a sample text and a sample image, and the sample text includes a sample text in a first language and a sample text in a second language; processing the sample text in the first language and the sample text in the second language by using the text encoding sub-model to obtain a sample text feature of the sample data; processing the sample image by using the image encoding sub-model to obtain a sample image feature of the sample data; and training the image-text retrieval model according to the sample text feature and the sample image feature.

According to an aspect of the present disclosure, there is provided a method of multimodal image retrieval, including: inputting an image retrieval text into an image-text retrieval model to obtain a text feature of the image retrieval text; determining N second similarities between the text feature and N image features; and determining, as a retrieval result, M images corresponding to M second similarities, which are greater than a predetermined similarity threshold, among the N second similarities, wherein N≥M; wherein the image-text retrieval model is trained by the method according to the present disclosure.

According to an aspect of the present disclosure, there is provided an electronic device, including: at least one processor; and a memory communicatively connected with the at least one processor; wherein the memory stores instructions executable by the at least one processor, and the instructions, when being executed by the at least one processor, cause the at least one processor to implement a method according to the present disclosure.

According to an aspect of the present disclosure, there is provided a non-transitory computer readable storage medium storing computer instructions, wherein the computer instructions are configured to cause a computer to implement a method according to the present disclosure.

It should be understood that the contents described in this section is not intended to identify key or vital features of embodiments of the present disclosure, nor is used to limit the scope of the present disclosure. Other features of the present disclosure will be become readily understood through the following descriptions.

### BRIEF DESCRIPTION OF THE DRAWINGS

The accompanying drawings are used for a better understanding of the present disclosure, and does not constitute a limitation on the present disclosure, in which:

FIG. 1 is a flowchart of a method of training an image-text retrieval model according to an embodiment of the present disclosure;

FIG. 2 is a flowchart of a method of training an image-text retrieval model according to another embodiment of the present disclosure;

FIG. 3 is a flowchart of a method of multimodal image retrieval according to an embodiment of the present disclosure;

FIG. 4 is a diagram of a principle of an image-text retrieval model according to an embodiment of the present disclosure;

FIG. 5 is a block diagram of an apparatus of training an image-text retrieval model according to an embodiment of the present disclosure;

FIG. 6 is a block diagram of an apparatus of multimodal image retrieval according to an embodiment of the present disclosure;

FIG. 7 is a block diagram of an electronic device used to implement a method training an image-text retrieval model and/or a method of multimodal image retrieval according to an embodiment of the present disclosure.

### DETAILED DESCRIPTION OF EMBODIMENTS

In the following, the exemplary embodiments of the present disclosure will be described with reference to the accompanying drawings, in which various details of embodiments of the present disclosure are included to facilitate understanding, and they should be considered as merely illustrative. Thus, those skilled in the art should recognize that various changes and modifications can be made to embodiments described here without departing from the scope and the spirit of the present disclosure. Descriptions of well-known functions and structures are omitted in the following descriptions for clarity and conciseness.

An image-text retrieval model, such as a contrastive language-image pre-training (CLIP) model may support a retrieval of image in association with text. An image encoder and a text encoder of the CLIP model may be established based on a Transformer model. When the CLIP model is used to perform image retrieval in an image base, a similarity between a feature of an image retrieval text and a feature of an image in the image base may be determined by comparison, and the image with a higher similarity may be determined as a retrieval result.

However, at present, the CLIP model only supports a text in English language, and a text in any other languages is required to be translated into English before being input into the CLIP model. It is impossible for the CLIP model to learn a relationship between a text in different languages and an image.

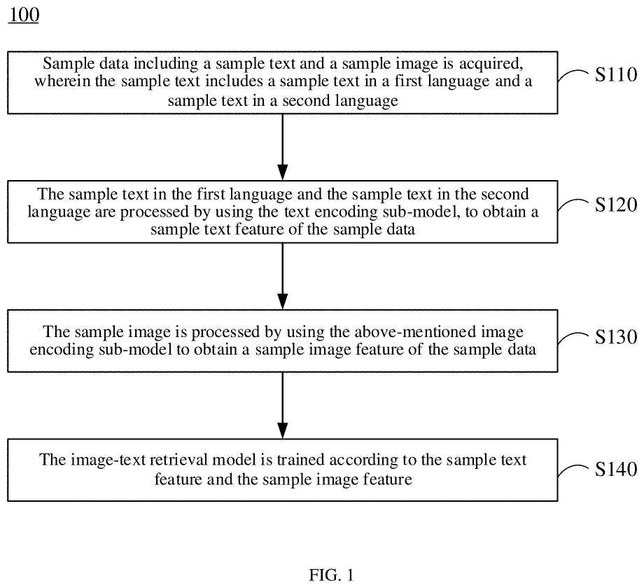

FIG. 1 is a flowchart of a method of training an image-text retrieval model according to an embodiment of the present disclosure.

As shown in FIG. 1, the method 100 of training an image-text retrieval model may include operations S110-S140. The image-text retrieval model may include a text encoding sub-model and an image encoding sub-model.

In step S110, sample data including a sample text and a sample image is acquired. The sample text includes a sample text in a first language and a sample text in a second language.

In embodiment of the present disclosure, the sample data may be acquired from a sample database.

For example, the sample database stores texts and images corresponding to the texts. In an example, the sample database stores texts and images in one-to-one correspondence, for example, a text is “ [symbol] ”, and an image corresponding to the text is an image of a man playing football. In an example, the sample database stores a text and at least one image corresponding to the text. For example, the text is “ [symbol] ”, and the image corresponding to the text may include an image of a national team player playing football, an image of a club player playing football, an image of a school student playing football and the like.

For another example, the sample database stores at least 500,000 texts and images corresponding to the at least 500,000 texts, with each text corresponding to 200 images. That is, the sample database stores at least 100,000,000 image-text pairs.

Those skilled in the art should understand that the sample database stores a plurality of sample texts and sample images corresponding to each sample text.

Those skilled in the art should understand that the acquired sample data may include a sample text and a sample image corresponding to the sample text. Alternatively, the acquired sample data may include a plurality of sample texts and sample images respectively corresponding to the plurality of sample texts.

For example, the sample text in the first language may be an English text, and the sample text in the second language may be a Chinese text.

In an embodiment of the present disclosure, the sample image may include a first sample image corresponding to the sample text in the first language, and a second sample image corresponding to the sample text in the second language.

For example, the sample text in the first language is “a man is playing football”, and the first sample image may be an image of a club player playing football. The sample text in the second language may be “ [symbol] ”, and the second sample image may also be an image of a club player playing football.

Those skilled in the art should understand that the first sample image and the second sample image may be the same image. When being input into an image-text retrieval model, the sample data is input into the image-text retrieval model in a form of two image-text pairs. For example, (“a man is playing football”, an image of a club player playing football) may be used as an image-text pair, and (“ [symbol] ”, an image of a club player playing football) may be used as another image-text pair. The two image-text pairs are both input into the image-text retrieval model.

In operation S120, the sample text in the first language and the sample text in the second language are processed by using the above-mentioned text encoding sub-model, to obtain a sample text feature of the sample data.

For example, the text encoding sub-model may implemented by the Transformer model.

For example, the text encoding sub-model may be a pre-trained sub-model.

In operation S130, the sample image is processed by using the above-mentioned image encoding sub-model, to obtain a sample image feature of the sample data.

For example, the image encoding sub-model may implemented by the Transformer model. For another example, the image encoding sub-model may implemented by a ResNet model.

For example, any one of the first sample image and the second sample image may be used as the sample image.

For example, the image encoding sub-model may be a pre-trained sub-model.

In operation S140, the image-text retrieval model is trained according to the sample text feature and the sample image feature as described above.

For example, parameters of the image-text retrieval model may be adjusted according to a difference or a similarity between the sample text feature and the sample image feature.

Those skilled in the art should understand that the sample text in the first language and the first sample image corresponding to the sample text in the first language may be used to pre-train the text encoding sub-model and the image encoding sub-model. In an example, the text encoding sub-model may be used to process the sample text in the first language to obtain a feature of the sample text in the first language, the image encoding sub-model may be used to process the first sample image to obtain a feature of the first sample image, and parameters of the text encoding sub-model and the image encoding sub-model may be adjusted according to a difference or a similarity between the feature of the sample text in the first language and the feature of the first sample image. A target of the training is to reduce the difference between the feature of the sample text in the first language and the feature of the first sample image, or increase the similarity between the feature of the sample text in the first language and the feature of the first sample image.

In an embodiment of the present disclosure, a relationship between a plurality of languages and the image may be effectively used to obtain an image-text retrieval model supporting retrieval of the plurality of languages, which may particularly improve the efficiency of retrieving images by using Chinese text. In addition, a large amount of sample data, such as at least 100,000.000 image-text pairs may be used, thereby improving the efficiency of training.

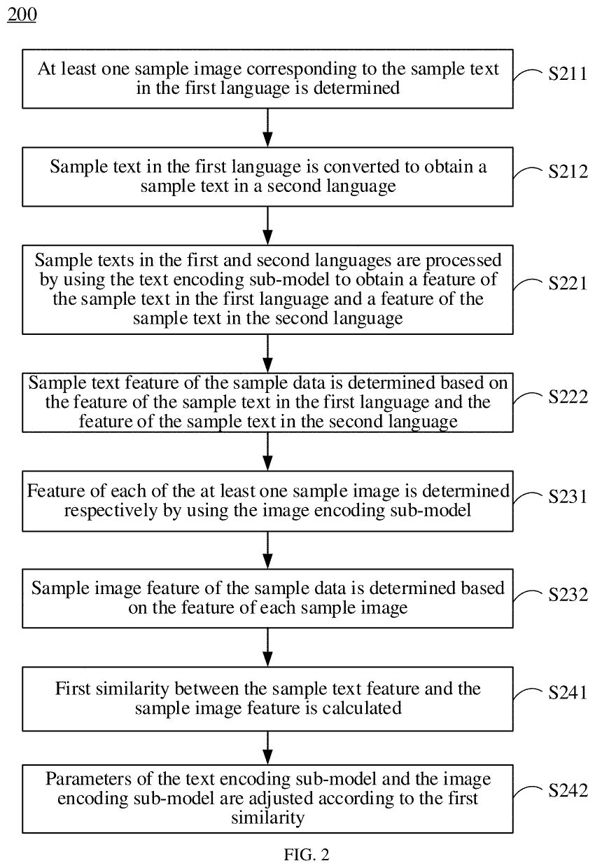

FIG. 2 is a flowchart of a method of training an image-text retrieval model according to an embodiment of the present disclosure.

As shown in FIG. 2, in the method 200 of training an image-text retrieval model, sample data may be acquired. This will be described below in detail with reference to the following operations S211-S212.

In operation S211, at least one sample image corresponding to the sample text in the first language as described above is determined.

For example, the sample database may stores only sample texts in the first language and sample images corresponding to the sample texts in the first language.

In operation S212, the sample text in the first language is converted to obtain a sample text in a second language.

For example, the sample text in the first language which is English may be converted into the sample text in the second language which is Chinese. In an example, a sample text in a first language stored in the sample database may be “a man is playing football”, which is translated to “ [symbol] ”, so that a sample text in a second language is obtained. The sample image corresponding to the sample text in the first language may be the image of a club player playing football. A corresponding relationship between the sample text in the second language and the sample image may be established to obtain two image-text pairs, one of which is (“a man is playing football”, the image of a club player playing football), and the other one of which is (“ [symbol] [symbol] ”, the image of a club player playing football). It is also possible to convert the sample text in the first language which is Chinese into the sample text in the second language which is English in the same or similar manner, which will not be repeated here.

Then, in the method 200 of training the image-text retrieval model, the above-mentioned text encoding sub-model may be used to process the sample text in the first language and the sample text in the second language so as to obtain sample text feature of the sample data. This will be described below in detail with reference to the following operations S221-S222.

In operation S221, the sample text in the first language and the sample text in the second language are processed by using the text encoding sub-model to obtain a feature of the sample text in the first language and a feature of the sample text in the second language.

For example, the text encoding sub-model may be used to process the sample text in the first language which is English to obtain the feature (T₁, T₂, . . . , Tᵢ) of the sample text in the first language, i≥3.

For example, the text encoding sub-model may be used to process the sample text in the second language which is Chinese to obtain the feature (Tᵢ₊₁, . . . , T_{K}) of the sample text in the second language, i≥3, K≥i.

In operation S222, the sample text feature of the sample data is determined based on the feature of the sample text in the first language and the feature of the sample text in the second language.

In an embodiment of the present disclosure, the sample text feature of the sample data may be determined by combining the feature of the sample text in the first language and the feature of the sample text in the second language.

For example, the combining operation may be a splicing operation, in which the feature (T₁, T₂, . . . , Tᵢ) of the sample text in the first language and the feature (Tᵢ₊₁, . . . , T_{K}) of the sample text in the second language are spliced to obtain the sample text feature (T₁, T₂, . . . , Tᵢ, Tᵢ₊₁, . . . , T_{K}).

In the method 200 of training the image-text retrieval model, it is also possible to process the above-mentioned sample image by using the above-mentioned image encoding sub-model so as to obtain the sample image feature of the sample data. This will be described below in detail with reference to the following operations S231-S232.

In operation S231, a feature of each of the at least one sample image is determined respectively by using the image encoding sub-model.

In an embodiment of the present disclosure, the number of the sample images may be one.

For example, the sample image may be the image of a club player playing football, and the feature (I₁, I₂, . . . , Iᵢ, Iᵢ₊₁, . . . , I_{K}) of the sample image may be determined by using the image encoding sub-model.

In an embodiment of the present disclosure, the number of the sample images may be greater than or equal to two.

For example, the number of the sample images may be three. The three sample images may be, for example, an image of a national team player playing football, an image of a club player playing football and an image of a school student playing football. The feature of each of the three sample images may be determined by using the image encoding sub-model, to obtain features (I₁₁, I₁₂, . . . , I₁ᵢ, I1₍ᵢ₊₁₎, . . . , I_{1J}), (I₂₁, I₂₂, . . . , I₂ᵢ, I₂₍ᵢ₊₁₎, . . . , I_{2J}) and (I₃₁, I₃₂, . . . , I₃ᵢ, I3 ₍ᵢ₊₁₎, . . . , I_{3J}) for the three sample images respectively, wherein j may be equal or not equal to k.

In operation S232, the sample image feature of the sample data is determined based on the feature of each sample image.

For example, when the number of the sample images is one, the feature (I₁, I₂, . . . , Iᵢ, Iᵢ₊₁, . . . , I_{K}) of the sample image may be directly used as the sample image feature.

For example, when the number of the sample images is greater than or equal to two, features of the these sample images may be combined (such as spliced or added linearly) to obtain the sample image feature. For example, the above described features (I₁₁, I₁₂, . . . , I₁ᵢ, I1 ₍ᵢ₊₁₎, . . . , I_{1J}), (I₂₁, I₂₂, . . . , I₂ᵢ, I_{2 (i+1)}, . . . , I_{2J}) and (I₃₁, I₃₂, . . . , I₃ᵢ, I3 ₍ᵢ₊₁₎, . . . , I_{3J}) may be combined to obtain the sample image feature (I₁′, I₂′, . . . , Iᵢ′, Iᵢ₊₁′, . . . , I_{K}′).

Then, the image-text retrieval model may be trained according to the sample text feature and the sample image feature in the method 200 of training the image text model. This will be described below in detail with reference to the following operations S241-S242.

In operation S241, a first similarity between the above-mentioned sample text feature and the above-mentioned sample image feature is calculated.

For example, the first similarity may have a value in a range of 0-1.

For example, a cosine similarity between the sample text feature (T₁, T₂, . . . , Tᵢ, Tᵢ₊₁, . . . , T_{K}) and the sample image feature (I₁, I₂, . . . , Iᵢ, Iᵢ₊₁, . . . , I_{K}) may be calculated as the first similarity.

For example, a cosine similarity between the sample text feature (T₁, T₂, . . . , Tᵢ, Tᵢ₊₁, . . . , T_{K}) and the sample image feature (I₁′, I₂′, . . . , Iᵢ′, Iᵢ₊₁′, . . . , I_{K}′) may be calculated as the first similarity.

In operation S242, the parameters of the above-mentioned text encoding sub-model and the above-mentioned image encoding sub-model are adjusted according to the first similarity.

For example, when the value of the first similarity is in the range of 0-1, the parameters of the text encoding sub-model and the image encoding sub-model may be adjusted to increase the value of the subsequently obtained first similarity.

Those skilled in the art should understand that after acquiring a set of sample data for training and adjusting the parameters of the text encoding sub-model and the image encoding sub-model, a next set of sample data may be acquired for the next training until the first similarity exceeds a predetermined value (such as 0.8) or reaches a predetermined training time, and the training is completed.

Those skilled in the art should understand that the operations S221-S222 may be performed in parallel with, before or after the operations S231-S232.

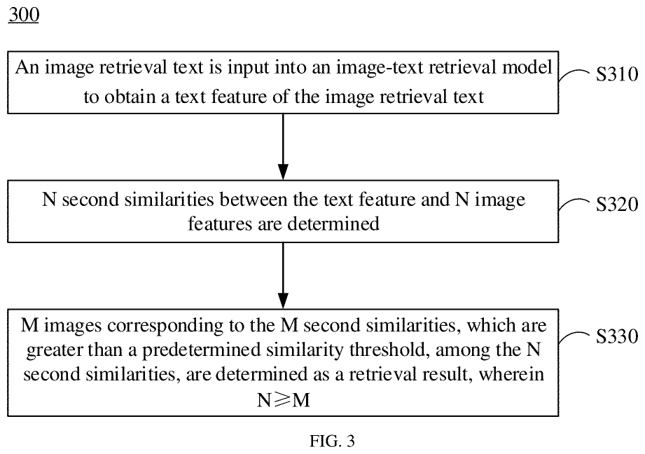

FIG. 3 is a flowchart of a method of multimodal image retrieval according to an embodiment of the present disclosure.

As shown in FIG. 3, the method of multimodal image retrieval includes operations S310-S330.

In operation S310, an image retrieval text is input into an image-text retrieval model to obtain text feature of the image retrieval text.

For example, the image retrieval text is “ [symbol] ”, which is processed by using the image-text retrieval model to obtain a feature of the image retrieval text.

In operation S320, N second similarities between the text feature and N image features are determined.

In an embodiment of the present disclosure, the N image features and the N images are in one-to-one correspondence. The N images are stored in an online database. In the online database, an index of each image in the N images is the image feature of each image. The image feature of each image is obtained by processing the each image using the image-text retrieval model.

For example, images published online or offline may be collected to obtain the online database. Then the image-text retrieval model is used to process each image in the online database to obtain the feature of each image, which is used as the index of this image.

For another example, the N second similarities may be N cosine similarities between the text feature of the text [symbol] and the N image features.

In operation S330, M images corresponding to the M second similarities, which are greater than a predetermined similarity threshold, among the N second similarities are determined as a retrieval result, wherein N≥M.

For example, the predetermined similarity threshold may be 0.6. If M image features in the online database have second similarities greater than 0.6 with respect to the text feature of “ [symbol] ”, M images corresponding to the M image features may be used as the retrieval result.

In an embodiment of the present disclosure, the image-text retrieval model may be trained by the method as shown in FIG. 2.

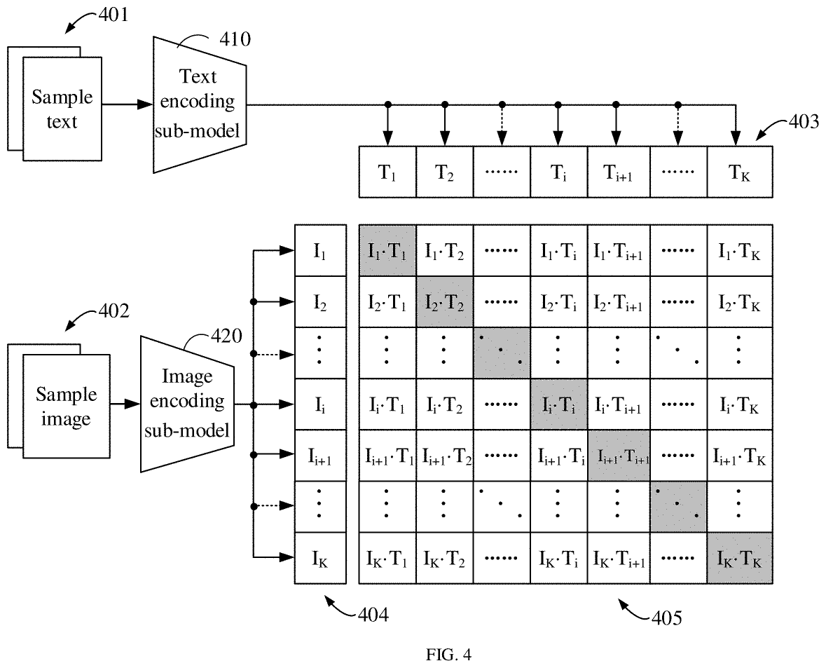

FIG. 4 is a diagram of a principle of an image-text retrieval model according to an embodiment of the present disclosure.

As shown in FIG. 4, the image-text retrieval model may include a text encoding sub-model 410 and an image encoding sub-model 420.

The sample data input into the image-text retrieval model may be an image-text pair such as (sample text, sample image). The sample text 401 may include a sample text in a first language and a sample text in a second language. That is, the sample data input into the image-text retrieval model may be two image-text pairs, i.e. (sample text in first language, sample image), and (sample text in second language, the sample image).

The sample text in the first language and the sample text in the second language are processed by the text encoding sub-model 410 to obtain the text feature 403 (T₁, T₂, . . . , Tᵢ, Tᵢ₊₁, . . . , T_{K}). The sample text in the first language is processed by the text encoding sub-model 410 to obtain T₁ to Tᵢ, and the sample text in the second language is processed by the text encoding sub-model 410 to obtain Tᵢ₊₁ to T_{K}.

The sample image is processed by the image encoding sub-model 420 to obtain the sample image feature 404 (I₁, I₂, . . . , Iᵢ, Iᵢ₊₁, . . . , I_{K}).

Parameters of the image-text retrieval model are adjusted according to the sample text feature 403 and the sample image feature 404. In an example, a first similarity matrix 405 may be obtained according to the sample text feature 403 and the sample image feature 404, and the first similarity matrix 405 may be processed by using a SoftMax layer to obtain a first similarity.

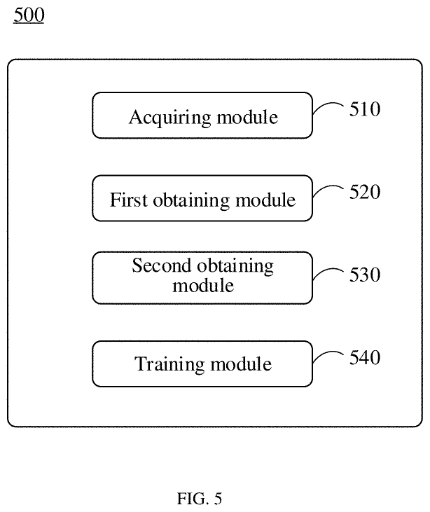

FIG. 5 is a block diagram of an apparatus of training an image-text retrieval model according to an embodiment of the present disclosure.

As shown in FIG. 5, the apparatus 500 of training an image-text retrieval model may include an acquiring module 510, a first obtaining module 520, a second obtaining module 530 and a training module 540. The image-text retrieval model as described above includes a text encoding sub-model and an image encoding sub-model.

The acquiring module 510 is used to acquire sample data. The sample data includes a sample text and a sample image, and the sample text includes a sample text in a first language and a sample text in a second language.

The first obtaining module 520 is used to process the sample text in the first language and the sample text in the second language by using the text encoding sub-model to obtain a sample text feature of the sample data.

The second obtaining module 530 is used to process the sample image by using the image encoding sub-model to obtain a sample image feature of the sample data.

The training module 540 is used to train the image-text retrieval model according to the sample text feature and the sample image feature.

In some embodiments, the training module includes: a computing unit used to calculate a first similarity between the sample text feature and the sample image feature; and an adjusting unit used to adjust a parameter of the text encoding sub-model and a parameter of the image encoding sub-model according to the first similarity.

In some embodiments, the first obtaining module includes: a first obtaining unit used to process the sample text in the first language by using the text encoding sub-model to obtain a feature of the sample text in the first language; a second obtaining unit used to process the sample text in the second language by using the text encoding sub-model to obtain a feature of the sample text in the second language; and a first determining unit used to determine the sample text feature of the sample data based on the feature of the sample text in the first language and the feature of the sample text in the second language.

In some embodiments, the sample data includes at least one sample image. The second obtaining module includes: a second determining unit used to determine a feature of each of the at least one sample image; and a third determining unit used to determine the sample image feature of the sample data based on the feature of each sample image.

In some embodiments, the acquiring module includes: a fourth determining unit used to determine at least one sample image corresponding to the sample text in the first language; and a converting unit used to convert the sample text in the first language so as to obtain the sample text in the second language.

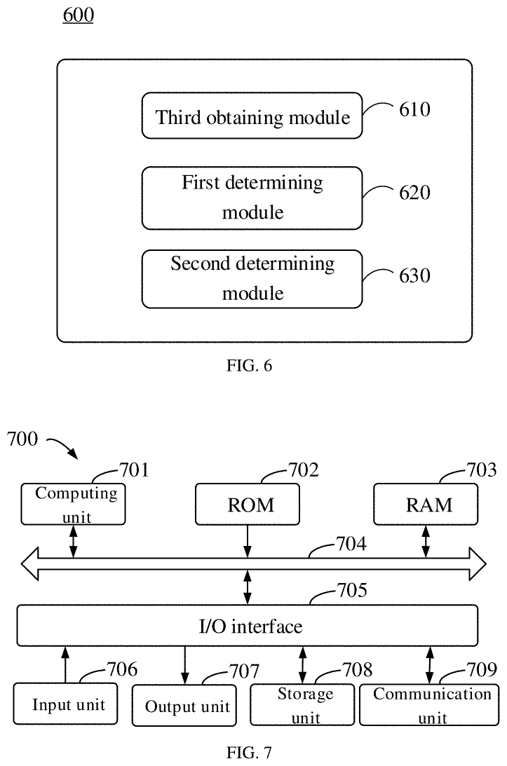

FIG. 6 is a block diagram of an apparatus of multimodal image retrieval according to an embodiment of the present disclosure.

As shown in FIG. 6, the apparatus 600 of multimodal image retrieval may include a third obtaining module 610, a first determining module 620 and a second determining module 630.

The third obtaining module 610 is used to input an image retrieval text into an image-text retrieval model to obtain a text feature of the image retrieval text.

The first determining module 620 is used to determine N second similarities between the text feature and N image features.

The second determining module 530 is used to determine, as a retrieval result, M images corresponding to M second similarities, which are greater than a predetermined similarity threshold, among the N second similarities wherein N≥M. The image-text retrieval model is trained by the apparatus according to the present disclosure.

In some embodiments, the N image features and the N images are in one-to-one correspondence, and the N images are stored in an online database. In the online database, an index of each image in the N images is the image feature of each image. The image features of each image is obtained by processing the each image using the image-text retrieval model.

Collecting, storing, using, processing, transmitting, providing, and disclosing etc. of the personal information of the user involved in the present disclosure all comply with the relevant laws and regulations, are protected by essential security measures, and do not violate the public order and morals. According to the present disclosure, personal information of the user is acquired or collected after such acquirement or collection is authorized or permitted by the user.

According to an embodiment of the present disclosure, the present disclosure further provides an electronic device, a readable storage medium and a computer program product.

FIG. 7 shows a schematic block diagram of an electronic device 700 suitable for the method of training the detection model and the method of detecting the target image according to embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 7, the electronic device 700 may include a computing unit 701, which may perform various appropriate actions and processing based on a computer program stored in a read-only memory (ROM) 702 or a computer program loaded from a storage unit 708 into a random access memory (RAM) 703. Various programs and data required for the operation of the electronic device 700 may be stored in the RAM 703. The computing unit 701, the ROM 702 and the RAM 703 are connected to each other through a bus 704. An input/output (I/O) interface 705 is also connected to the bus 704.

Various components in the electronic device 700, including an input unit 706 such as a keyboard, a mouse, etc., an output unit 707 such as various types of displays, speakers, etc., a storage unit 708 such as a magnetic disk, an optical disk, etc., and a communication unit 709 such as a network card, a modem, a wireless communication transceiver, etc., are connected to the I/O interface 705. The communication unit 709 allows the electronic device 700 to exchange information/data with other devices through a computer network such as the Internet and/or various telecommunication networks.

The computing unit 701 may be various general-purpose and/or special-purpose processing components with processing and computing capabilities. Some examples of the computing unit 701 include but are not limited to a central processing unit (CPU), a graphics processing unit (GPU), various dedicated artificial intelligence (AI) computing chips, various computing units running machine learning model algorithms, a digital signal processor (DSP), and any appropriate processor, controller, microcontroller, and so on. The computing unit 701 may perform the various methods and processing described above, such as the method of training the image-text retrieval model and/or the method of multimodal image retrieval. For example, in some embodiments, the method of training the image-text retrieval model and/or the method of multimodal image retrieval may be implemented as a computer software program that is tangibly contained on a machine-readable medium, such as a storage unit 708. In some embodiments, part or all of a computer program may be loaded and/or installed on the electronic device 700 via the ROM 702 and/or the communication unit 709. When the computer program is loaded into the RAM 703 and executed by the computing unit 701, one or more steps of the method of training the image-text retrieval model and/or the method of multimodal image retrieval described above may be performed. Alternatively, in other embodiments, the computing unit 701 may be configured to perform the method of training the image-text retrieval model and/or the method of multimodal image retrieval in any other appropriate way (for example, by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from the storage system, the at least one input device and the at least one output device, and may transmit the data and instructions to the storage system, the at least one input device, and the at least one output device.

Program codes for implementing the method of the present disclosure may be written in any combination of one or more programming languages. These program codes may be provided to a processor or a controller of a general-purpose computer, a special-purpose computer, or other programmable data processing devices, so that when the program codes are executed by the processor or the controller, the functions/operations specified in the flowchart and/or block diagram may be implemented. The program codes may be executed completely on the machine, partly on the machine, partly on the machine and partly on the remote machine as an independent software package, or completely on the remote machine or the server.

In the context of the present disclosure, the machine readable medium may be a tangible medium that may contain or store programs for use by or in combination with an instruction execution system, device or apparatus. The machine readable medium may be a machine-readable signal medium or a machine-readable storage medium. The machine readable medium may include, but not be limited to, electronic, magnetic, optical, electromagnetic, infrared or semiconductor systems, devices or apparatuses, or any suitable combination of the above. More specific examples of the machine readable storage medium may include electrical connections based on one or more wires, portable computer disks, hard disks, random access memory (RAM), read-only memory (ROM), erasable programmable read-only memory (EPROM or flash memory), optical fiber, convenient compact disk read-only memory (CD-ROM), optical storage device, magnetic storage device, or any suitable combination of the above.

In order to provide interaction with users, the systems and techniques described here may be implemented on a computer including a display device (for example, a CRT (cathode ray tube) or LCD (liquid crystal display) monitor) for displaying information to the user), and a keyboard and a pointing device (for example, a mouse or a trackball) through which the user may provide the input to the computer. Other types of devices may also be used to provide interaction with users. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and Internet.

A computer system may include a client and a server. The client and the server are generally far away from each other and usually interact through a communication network. The relationship between the client and the server is generated through computer programs running on the corresponding computers and having a client-server relationship with each other. The server may be a cloud server, and may also be a server of a distributed system, or a server combined with a block-chain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method of training an image-text retrieval model, wherein the image-text retrieval model comprises a text encoding sub-model and an image encoding sub-model, and the method comprises:
acquiring sample data, wherein the sample data comprises a sample text and a sample image, and the sample text comprises a sample text in a first language and a sample text in a second language;
processing the sample text in the first language and the sample text in the second language by using the text encoding sub-model to obtain a sample text feature of the sample data;
processing the sample image by using the image encoding sub-model to obtain a sample image feature of the sample data; and
training the image-text retrieval model according to the sample text feature and the sample image feature.

2. The method according to claim 1, wherein the training the image-text retrieval model comprises:
calculating a first similarity between the sample text feature and the sample image feature; and
adjusting a parameter of the text encoding sub-model and a parameter of the image encoding sub-model according to the first similarity.

3. The method according to claim 1, wherein the processing the sample text in the first language and the sample text in the second language comprises:
processing the sample text in the first language by using the text encoding sub-model to obtain a feature of the sample text in the first language;
processing the sample text in the second language by using the text encoding sub-model to obtain a feature of the sample text in the second language; and
determining the sample text feature of the sample data based on the feature of the sample text in the first language and the feature of the sample text in the second language.

4. The method according to claim 2, wherein the processing the sample text in the first language and the sample text in the second language comprises:
processing the sample text in the first language by using the text encoding sub-model to obtain a feature of the sample text in the first language;
processing the sample text in the second language by using the text encoding sub-model to obtain a feature of the sample text in the second language; and
determining the sample text feature of the sample data based on the feature of the sample text in the first language and the feature of the sample text in the second language.

5. The method according to claim 1, wherein the sample data comprises at least one sample image; and
wherein the processing the sample image comprises:
determining a feature of each of the at least one sample image respectively by using the image encoding sub-model; and
determining the sample image feature of the sample data based on the feature of each sample image.

6. The method according to claim 1, wherein the acquiring the sample data comprises:
determining at least one sample image corresponding to the sample text in the first language; and
converting the sample text in the first language to obtain the sample text in the second language.

7. A method of multimodal image retrieval, the method comprising:
inputting an image retrieval text into an image-text retrieval model to obtain a text feature of the image retrieval text;
determining N second similarities between the text feature and N image features; and
determining, as a retrieval result, M images corresponding to M second similarities, which are greater than a predetermined similarity threshold, among the N second similarities, wherein N≥M;
wherein the image-text retrieval model is trained by the method according to claim 1.

8. The method according to claim 7, wherein the N image features and the N images are in one-to-one correspondence, and the N images are stored in an online database; and
wherein in the online database, an index of each image in the N images is the image feature of the each image which is obtained by processing the each image using the image-text retrieval model.

9. The method according to claim 7, wherein the training the image-text retrieval model comprises:
calculating a first similarity between the sample text feature and the sample image feature; and
adjusting a parameter of the text encoding sub-model and a parameter of the image encoding sub-model according to the first similarity.

10. The method according to claim 7, wherein the processing the sample text in the first language and the sample text in the second language comprises:
processing the sample text in the first language by using the text encoding sub-model to obtain a feature of the sample text in the first language;
processing the sample text in the second language by using the text encoding sub-model to obtain a feature of the sample text in the second language; and
determining the sample text feature of the sample data based on the feature of the sample text in the first language and the feature of the sample text in the second language.

11. The method according to claim 7, wherein the sample data comprises at least one sample image; and
wherein the processing the sample image comprises:
determining a feature of each of the at least one sample image respectively by using the image encoding sub-model; and
determining the sample image feature of the sample data based on the feature of each sample image.

12. The method according to claim 7, wherein the acquiring a sample data comprises:
determining at least one sample image corresponding to the sample text in the first language; and
converting the sample text in the first language to obtain the sample text in the second language.

13. An electronic device, comprising:
at least one processor; and
a memory communicatively connected with the at least one processor, wherein the memory stores instructions executable by the at least one processor, and the instructions, when executed by the at least one processor, are configured to cause the at least one processor to implement at least the method according to claim 1.

14. The electronic device according to claim 13, wherein the instructions are further configured to cause the at least one processor to:
calculate a first similarity between the sample text feature and the sample image feature; and
adjust a parameter of the text encoding sub-model and a parameter of the image encoding sub-model according to the first similarity.

15. An electronic device, comprising:
at least one processor; and
a memory communicatively connected with the at least one processor, wherein the memory stores instructions executable by the at least one processor, and the instructions, when executed by the at least one processor, are configured to cause the at least one processor to implement at least the method according to claim 7.

16. The electronic device according to claim 15, wherein the N image features and the N images are in one-to-one correspondence, and the N images are stored in an online database; and
wherein in the online database, an index of each image in the N images is the image feature of the each image which is obtained by processing the each image using the image-text retrieval model.

17. A non-transitory computer readable storage medium storing computer instructions therein, the computer instructions, when executed by a computer system, are configured to cause the computer system to implement at least the method according to claim 1.

18. The storage medium according to claim 17, wherein the computer instructions are further configured to cause the computer system to:
calculate a first similarity between the sample text feature and the sample image feature; and
adjust a parameter of the text encoding sub-model and a parameter of the image encoding sub-model according to the first similarity.

19. A non-transitory computer readable storage medium storing computer instructions therein, the computer instructions, when executed by a computer system, are configured to cause the computer system to implement at least the method according to claim 7.

20. The storage medium according to claim 19, wherein the N image features and the N images are in one-to-one correspondence, and the N images are stored in an online database; and
wherein in the online database, an index of each image in the N images is the image feature of the each image which is obtained by processing the each image using the image-text retrieval model.
